(19) United States
(12) Patent Application Publication
(10) Pub. No.: US 2006/0082246 A1
(43) Pub. Date: Apr. 20, 2006

(54) Geared motor and method for the assembly of the geared motor

(76) Inventors: Laurent Robin, Ouzouer-Le-Marche (FR); Mickael Lebourgeois, Auvilliers En Gatinais (FR); Marie-Pierre Bena, Cerdon Du Loiret (FR)

Correspondence Address: CARLSON, GASKEY & OLDS, P.C., 400 WEST MAPLE ROAD, SUITE 350, BIRMINGHAM, MI, 48009, US

(21) Appl. No.: 11/249,148

(22) Filed: Oct. 12, 2005

(30) Foreign Application Priority Data
Oct. 15, 2004 (FR) 04 10 940

(51) Int. Cl. H02K 7/10; H01R 39/38

(52) U.S. Cl. 310/239; 310/83

(57) ABSTRACT

A geared motor includes a control board for controlling the geared motor and a brush holder in electrical contact with the control board. The brush holder locks the control board in the geared motor. The assembly of the geared motor is facilitated, reducing the assembly costs.

### REFERENCE TO RELATED APPLICATION

This application claims priority to French Patent Application FR 04 10 940 filed on Oct. 15, 2004.

### BACKGROUND OF THE INVENTION

This invention relates generally to a geared motor and a method for the assembly of a geared motor.

Vehicles can be provided with equipment, such as window regulators or sun roofs. This equipment can be electrically actuated, in particular by a geared motor. The geared motor can include a motor driving a reduction gear that is linked to a window or a sliding roof. Coils of the motor are powered by a commutator that receives supply current via brushes. The brushes are fixed relative to the geared motor and are in electrical rubbing contact with the commutator that is rotated by the motor. Moreover, the geared motor can include a control board that controls the operation of the motor. The geared motor therefore includes a plurality of components, which can cause problems for the assembly of the components.

### SUMMARY OF THE INVENTION

The present invention provides a geared motor including a control board for controlling the geared motor and a brush holder in electrical contact with the control board. The brush holder locks the control board in the geared motor.

According to one embodiment, the brush holder prevents the control board from translating in the geared motor. According to one embodiment, the geared motor includes a rotor, and the brush holder prevents the control board from translating along the rotor. According to another embodiment, the geared motor also includes brushes. The brush holder includes two arms supporting the brushes which are diametrically opposed relative to the rotor. According to one embodiment, the brush holder is in electrical contact with the control board via the arms. According to yet another embodiment, the geared motor includes a housing, and the brush holder forces the control board against the housing.

The invention also relates to a method for assembling a geared motor as described previously. The method includes the steps of inserting the control board and the brush holder into the geared motor, locking the brush holder and placing the brush holder and the control board in electrical contact.

According to one embodiment, the geared motor includes a rotor slot, and the control board and the brush holder are inserted along the rotor slot. According to one embodiment, the geared motor includes a reduction gear and a housing. The reduction gear is in the housing, and the control board and the brush holder are inserted into the housing. According to one embodiment, the brush holder is inserted into the housing by force.

### BRIEF DESCRIPTION OF THE DRAWINGS

Other characteristics and advantages of the invention will become apparent on reading the following detailed description of the embodiments of the invention, given as an example only and with reference to the drawings, which show:

FIG. 1 shows a longitudinal sectional view of a geared motor;

FIG. 2 shows a transverse sectional view of the geared motor;

FIG. 3 shows a view of a brush holder; and

FIG. 4 shows a lateral view of a brush holder.

### DETAILED DESCRIPTION OF THE PREFERRED EMBODIMENT

The invention relates to a geared motor including a control board for controlling the geared motor and a brush holder. The brush holder is in electrical contact with the control board and locks the control board in the geared motor, facilitating the assembly of the geared motor and reducing the assembly costs.

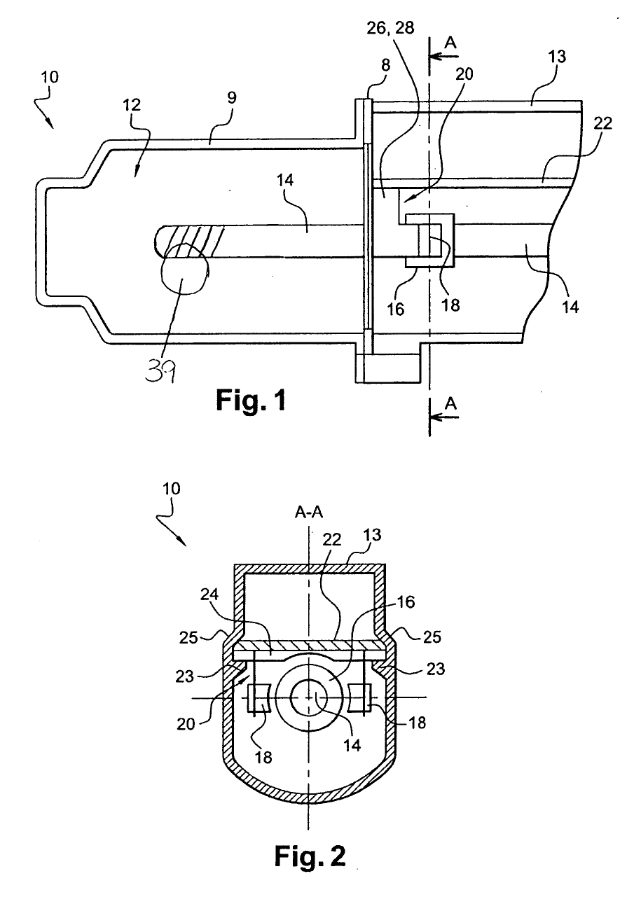

FIG. 1 shows a longitudinal sectional view of a geared motor 10. The geared motor 10 includes a motor 12 and a housing 13, the motor 12 being fixed to the housing 13. The motor 12 includes a stator 9 and a rotor 14 composed of coils on a rotating shaft (in the drawing, only the shaft is shown). The rotor 14 drives a reduction gear 39 composed of a worm (on the rotor 14) and a gear wheel. The reduction gear 39 is in the housing 13. The coils of the rotor 14 are supplied with power by a commutator 16 integral with the rotor 14 and brushes 18 that transmit the supply current to the motor 12. The brushes 18 transmit the supply current to the commutator 16 even while the commutator 16 is rotating. The brushes 18 are held in the geared motor 10 using a brush holder 20 that allows the brushes 18 to be held and positioned opposite the commutator 16. The brushes 18 are diametrically opposed relative to the commutator 16. The motor 12 is fixed to an interface 8 of the housing 13 and includes an opening for introducing the rotor 14.

The geared motor 10 also includes a control board 22 for controlling the operation of the geared motor 10. For example, the control board 22 controls the start-up of the motor 12, the reversal of its direction of rotation, or its stopping. The control board 22 is of the printed circuit type. The brush holder 20 is electrically connected to the control board 22, and the control board 22 thus allows for control of the passage of the electric current towards the brush holder 20. Moreover, the brush holder 20 locks the control board 22 in the geared motor 10, which makes additional board locking elements unnecessary. This facilitates the assembly of the geared motor 10 because the insertion of the brush holder 20 positions the brush holder 20 and immobilizes the control board 22 at the same time.

The control board 22 is in the housing 13 of the geared motor 10. Thus, the use of an additional recess for the control board 22 is avoided, making the geared motor 10 more compact. The bulk of the geared motor 10 is therefore reduced. Moreover, the elimination of an external recess for the control board 22 reduces the production costs. The housing 13 can, for example, include grooves into which the control board 22 is inserted. The brush holder 20, which is a separate component from the control board 22, can thus prevent the translation of the control board 22, in particular in the grooves.

The control board 22 can extend parallel (along the largest dimension of the control board 22) to the rotor 14, and the brush holder 20 prevents the translation of the control board 22 along the rotor 14. This is advantageous for the assembly of the geared motor 10 because the rotor 14 and the control board 22 can be inserted along the same axis, and the control board 22 is thus immobilized in a simple way by the brush holder 20 along this axis.

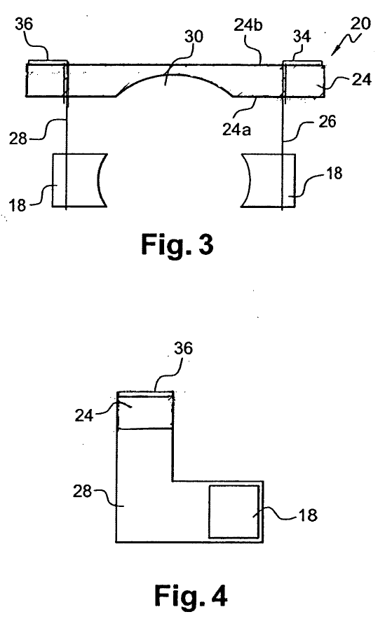

FIG. 2 shows a transverse sectional view of the geared motor 10. The rotor 14, the control board 22 and the brush holder 20 holding the brushes 18 are visible in cross section. The brushes 18 are held in front of the commutator 16. The brush holder 20 includes a plate 24 and arms 26 and 28 supporting the brushes 18 (see FIG. 3). The plate 24 locks the control board 22, in particular when it is inserted in the housing 13 along the rotor 14. The arms 26 and 28 are chosen with a size and shape that allow for the positioning of the brushes 18 in front of the commutator 16.

The brush holder 20 forces the control board 22 against the housing 13 to lock the control board 22. For example, the brush holder 20 can prevent the control board 22 from translating by forcing the brush holder 20 into the reception grooves of the control board 22 (these grooves are situated in the housing 13, along projections 25 on the housing 13). The control board 22 is thus locked between the bottom of the housing 13 and the brush holder 20 at the opening of the housing 13. Alternatively, the brush holder 20 can push the control board 22 against the housing 13 in a direction transverse to the rotor 14, upwards in FIG. 2. The beginning of the reception grooves of the control board 22 at the interface 8 of the housing 13 can be widened transverse to the control board 22 into a cavity. The brush holder 20 can be housed in the cavity at least partially between the rotor 14 and the control board 22. In FIG. 2, the brush holder 20 is at least partially beneath the control board 22 and forces the control board 22 against the housing 13.

The housing 13 can include tabs 23 that project into the cavity to improve the robustness of the locking of the control board 22. The tabs 23 elastically force the brush holder 20 against the control board 22, and thus the control board 22 against the housing 13.

Moreover the presence of the brush holder 20 between the control board 22 and the rotor 14 easily establishes the electrical contact, as will be explained below in relation to FIG. 3.

FIG. 3 shows a view of the brush holder 20. The brush holder 20 includes the plate 24 from which the arms 26 and 28 extend. Because the brush holder 20 allows the brushes 18 to be held in front of the commutator 16 and has a larger diameter than the rotor 14, the brush holder 20 can include a recess 30 to allow the commutator 16 to rotate. This avoids an increase in the bulk of the geared motor 10 due to the brush holder 20.

The arms 26 and 28 extend on either side of the plate 24 and project from one side 24a of the plate 24 to hold the brushes 18. The arms 26 and 28 extend transverse to the plate 24 and also project from the other side 24b of the plate 24 to contact the control board 22.

The electrical contact of the brush holder 20 can be realized as follows. The arms 26 and 28 are pushed against the side 24b of the plate 24. The arms 26 and 28 thus form conductors 34 and 36 which are able to establish contact with the control board 22. Relative to FIG. 2, the brush holder 20 is between the control board 22 and the rotor 14. The conductors 34 and 36 are pressed against the control board 22, which has electric contact surfaces. The pressing of the brush holder 20 against the control board 22 by the tabs 23 of the housing 13 ensures the electrical contact.

FIG. 4 shows a lateral view of the brush holder 20. The plate 24 in cross section, one of the arms 28 extending from the plate 24, a conductor 36 and a brush 18 held by the brush holder 20 are shown. The arm 28 is L-shaped and pushes the brush 18 along the rotor 14 towards the commutator 16. The shape of the arm 28 is not limited to that shown in FIG. 4, but it is suited to the space available in the geared motor 10 and to the position of the brush holder 20 to lock the control board 22 relative to the commutator 16. The arms 26 and 28 can also, through their deformation, allow the brushes 18 to be elastically pushed against the commutator 16. This ensures a good electrical contact between the commutator 16 and the brushes 18, even after a long period of use.

Moreover, the geared motor 10 can be the subject of an assembly method. The geared motor 10 can include a motor 12 with a rotating rotor 14, a housing 13 to which the motor 12 is fixed and in which the rotor 14 extends, and a reduction gear 39 in the housing 13. The reduction gear 39 is driven by the rotor 14.

Before assembling the motor 12 and the rotor 14 in the housing 13, the method includes a step of assembling a control board 22 and a brush holder 20 in the geared motor 10. The method further includes a step of inserting the control board 22 and the brush holder 20 into the geared motor 10. More particularly, the control board 22 and the brush holder 20 are inserted into the housing 13 along the rotor 14. The insertion of the control board 22 and the brush holder 20 in the same direction as the insertion of the rotor 14 allows for only one common opening in the housing 13 for these components, simplifying the structure of the housing 13.

The method then includes a step of locking the brush holder 20 and making electrical contact between the control board 22 and the brush holder 20. Thus, the assembly of the control board 22 and the brush holder 20 is simple, rapid and does not require any additional operations. The locking of the brush holder 20 in the geared motor 10 is carried out, for example, by wedging the control board 22 against the housing 13 with the brush holder 20, in particular in a cavity provided for this purpose. Advantageously, the brush holder 20 is inserted by force into the housing 13, which improves the locking of the control board 22 in the housing 13 and the electrical contact of the control board 22 and the brush holder 20.

The method can also include the assembly of the rotor 14 in the housing 13. The rotor 14 can support the commutator 16 and coils. The rotor 14 is thus introduced into the housing 13 parallel to the control board 22 and locked by the brush holder 20. Thus, the immobilized control board 22 and the brush holder 20 do not hinder the insertion of the rotor 14. Moreover, the arms 26 and 28 of the brush holder 20 can be moved apart so that the commutator 16 can be positioned between the brushes 18 to establish the electrical contact. The mounting of the motor 12 is completed by assembling and fixing the casing containing the stator 9 to the housing 13.

Of course, this invention is not limited to the embodiments described as an example. Thus, the geared motor 10 is not limited to a driving device for a vehicle window or sliding roof.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A geared motor comprising:
a rotor having an axis;
a board for controlling the geared motor; and
a brush holder in electrical contact with the board, wherein the brush holder locks the board in the geared motor, and the board and the brush holder are insertable in a direction substantially along the axis of the rotor.

2. The geared motor according to the claim 1, wherein the brush holder prevents translation of the board in the geared motor.

3. The geared motor according to claim 1, wherein the brush holder prevents translation of the board along the rotor.

4. The geared motor according to claim 3, wherein the geared motor comprises brushes and the brush holder comprises two arms supporting the brushes which are diametrically opposed relative to the rotor.

5. The geared motor according to claim 4, wherein the brush holder is in electrical contact with the board via the two arms.

6. The geared motor according to claim 3, wherein the geared motor comprises a housing and the brush holder forces the board against the housing.

7. The geared motor according to claim 1, wherein a largest dimension of the board extends substantially parallel to the rotor.

8. A geared motor comprising:
a housing;
a rotor;
a board for controlling the geared motor; and
a brush holder in electrical contact with the board, wherein the brush holder locks the board in the geared motor by forcing the board against the housing.

9. The geared motor according to claim 8, wherein the brush holder prevents translation of the board along the rotor.

10. The geared motor according to claim 8, wherein a largest dimension of the board extends substantially parallel to the rotor.

11. The geared motor according to claim 8, wherein the geared motor comprises brushes and the brush holder comprises two arms supporting the brushes which are diametrically opposed relative to the rotor.

12. The geared motor according to claim 11, wherein the brush holder is in electrical contact with the board via the two arms.

13. A method for assembling a geared motor having a rotor with an axis, a board for controlling the geared motor and a brush holder in electrical contact with the board, the method comprising the steps of:
inserting the board and the brush holder into the geared motor in a direction substantially along the axis of the rotor;
locking the brush holder; and
electrically contacting the brush holder and the board to each other.

14. The method according to claim 13, wherein the step of inserting the board and the brush holder includes inserting the board and the brush holder along the rotor.

15. The method according to claim 14, wherein the geared motor comprises a housing and a reduction gear in the housing, and the step of inserting the board and the brush holder includes inserting the board and the brush holder into the housing.

16. The method according to claim 15, wherein the step of inserting the board and the brush holder into the housing includes inserting the brush holder by force.

17. The method according to claim 13, wherein a largest dimension of the board is inserted substantially parallel to the rotor.
